(19) United States
(12) Patent Application Publication
(10) Pub. No.: US 2025/0297931 A1
(43) Pub. Date: Sep. 25, 2025

(54) COMB TOOTH COMPONENT, WELDING STRENGTH DETECTION DEVICE AND METHOD

(71) Applicants: Tyco Electronics (Dongguan) Ltd., Dongguan City (CN); TE Connectivity Solutions GmbH, Schaffhausen (CH); Tyco Electronics (Shanghai) Co., Ltd., Shanghai (CN)

(72) Inventors: Senmiao Hu, Shanghai (CN); Lei (Alex) Zhou, Shanghai (CN); Xuyan Yu, Dongguan (CN); Yi Li, Dongguan (CN); Yong (Arvin) Liu, Dongguan (CN); Dandan (Emily) Zhang, Shanghai (CN); Roberto Francisco-Yi Lu, Bellevue, WA (US); Hongzhou (Andy) Shen, Dongguan (CN)

(73) Assignees: Tyco Electronics (Dongguan) Ltd., Dongguan City (CN); TE Connectivity Solutions GmbH, Schaffhausen (CH); Tyco Electronics (Shanghai) Co., Ltd., Shanghai (CN)

(21) Appl. No.: 19/085,058

(22) Filed: Mar. 20, 2025

(30) Foreign Application Priority Data
Mar. 20, 2024 (CN) 202410323586.9

(51) Int. Cl. G01N 3/08; G01N 3/06; G06T 7/00

(52) U.S. Cl. CPC G01N 3/08; G01N 3/068; G06T 7/0004

(57) ABSTRACT

A comb tooth component for detecting a welding strength of a welding point of a row of welding points includes a connection block, and a row of elastic arms. The row of elastic arms is connected to one side of the connection block. The row of elastic arms has a comb tooth shape. The row of elastic arms extends along a longitudinal direction and is arranged in a row in a transverse direction perpendicular to the longitudinal direction. End portions of the row of elastic arms are arranged alternately with the row of welding points. The row of elastic arms sequentially push the row of welding points under a push of a transversally moving detection finger to detect the welding strength of the row of welding points.

### CROSS-REFERENCE TO RELATED APPLICATION

This application claims the benefit of the filing date under 35 U.S.C. § 119(a)-(d) of Chinese Patent Application No. CN202410323586.9 filed on Mar. 20, 2024.

### FIELD OF THE INVENTION

The present invention relates to a comb tooth component, a welding strength detection device, and a method and, more particularly, to a comb tooth component for detecting the welding strength of welding points, a welding strength detection device comprising the comb tooth component, and a method for detecting the welding strength of welding points on a welded product using the welding strength detection device.

### BACKGROUND OF THE INVENTION

In the prior art, a force detection device with a detection finger is usually used to detect whether the welding strength of the welding points on the welded product has reached the predetermined welding strength. During detection, the detection finger is moved transversally, and the detected welding point is pushed transversally. If the welding strength of the welding point reaches the predetermined welding strength, the welding point will not loosen, and the detection finger will cross the welding point transversally. If the welding strength of the welding point does not reach the predetermined welding strength, the welding point will loosen under the push of the detection finger.

In the prior art, the detection finger directly contacts the welding points and crosses them transversally. However, the irregular appearance of welding points, such as being too large or too small, can affect the accuracy of the detection results. In addition, direct contact between the detection finger and the welding points can scratch the outer surface of the welding points.

### SUMMARY OF THE INVENTION

A comb tooth component for detecting a welding strength of a welding point of a row of welding points includes a connection block, and a row of elastic arms. The row of elastic arms is connected to one side of the connection block. The row of elastic arms has a comb tooth shape. The row of elastic arms extends along a longitudinal direction and is arranged in a row in a transverse direction perpendicular to the longitudinal direction. End portions of the row of elastic arms are arranged alternately with the row of welding points. The row of elastic arms sequentially push the row of welding points under a push of a transversally moving detection finger to detect the welding strength of the row of welding points.

### BRIEF DESCRIPTION OF THE DRAWINGS

The invention will now be described by way of example with reference to the accompanying figures, of which:

FIG. 1 is a plan view of a welding strength detection device according to an exemplary embodiment;

FIG. 2 is a perspective view of a comb tooth component of the welding strength detection device of FIG. 1 according to an exemplary embodiment;

FIG. 3 is a perspective view of a row of elastic arms of the comb tooth component of FIG. 2, a row of welding points of a welded product, and a detection finger of a force detection device according to an exemplary embodiment;

FIG. 4 is a plan view of the row of elastic arms of FIG. 3, the row of welding points of FIG. 3, and the detection finger of FIG. 3 viewed longitudinally; and

FIG. 5 is a plan view of the row of elastic arms of FIG. 3, the row of welding points of FIG. 3, and the detection finger of FIG. 3 viewed vertically.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

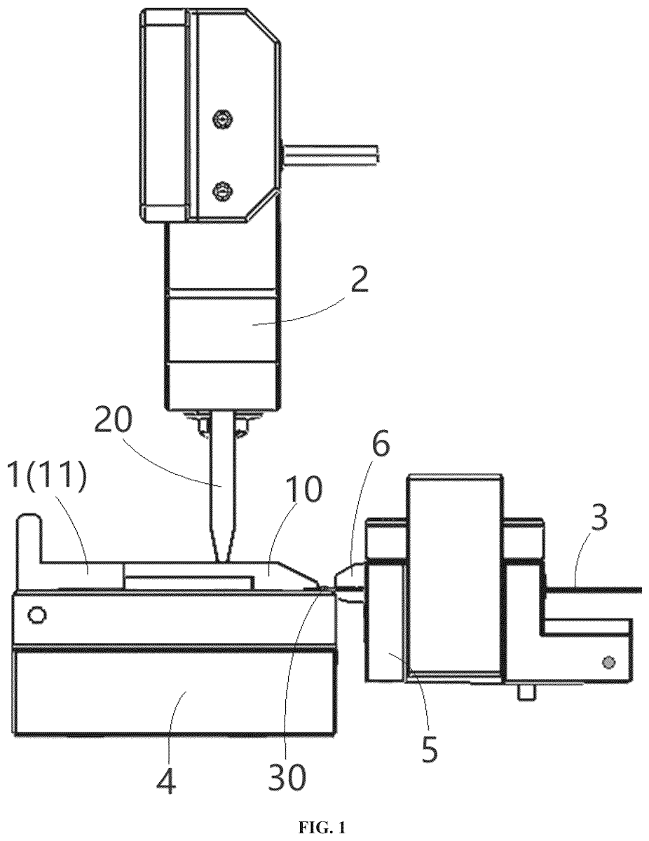

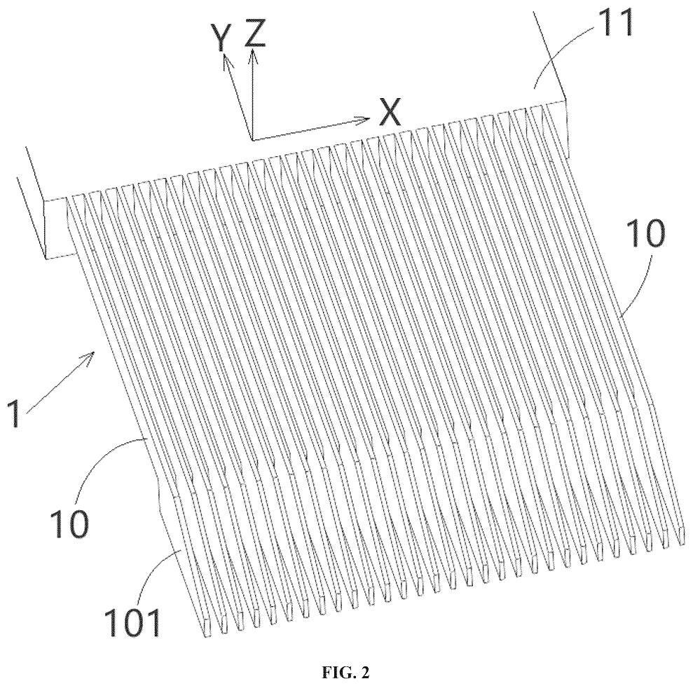

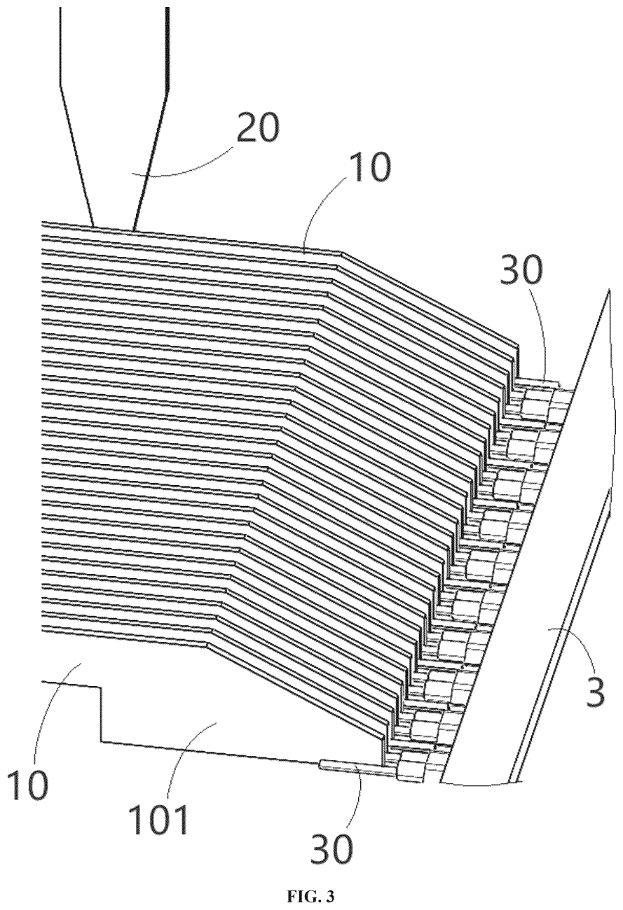

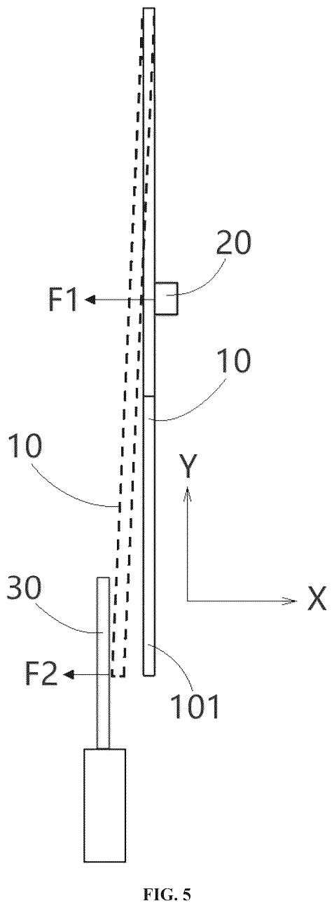

An exemplary embodiment of a comb tooth component 1 will now be described with reference to FIGS. 1-5. The comb tooth component 1, as shown in FIG. 1, is used to detect the welding strength of welding points 30. The comb tooth component 1 includes a connection block 11, as shown in FIGS. 1-2, and a row of elastic arms 10, as shown in FIGS. 1-5. The row of elastic arms 10 is connected to one side of the connection block 11. The row of elastic arms 10 extends along the longitudinal direction Y and is arranged in a row in the transverse direction X perpendicular to the longitudinal direction Y, making the row of elastic arms 10 comb like. As shown in FIGS. 3 and 5, the end portions 101 of the row of elastic arms 10 are adapted to be arranged alternately with a row of welding points 30, so that the row of elastic arms 10 can sequentially push the row of welding points 30 under the push of the transversally moving detection finger 20 to detect the welding strength of the row of welding points 30.

When the welding strength of the welding point 30 does not reach a predetermined welding strength, the welding point 30 will loosen under the push of the end portion 101 of the elastic arm 10. However, when the welding strength of welding point 30 reaches the predetermined welding strength, the welding point 30 will not loosen under the push of the end portion 101 of the elastic arm 10.

As shown in FIGS. 2-3, the elastic arm 10 is in the form of a sheet, with upper and lower sides opposite in the vertical direction Z perpendicular to the transverse direction X and the longitudinal direction Y. The lower side edge of the end portion 101 of the elastic arm 10, as shown in FIG. 3, is adapted to rest against one side of the welding point 30 along the transverse direction X, so as to be able to push the welding point 30 along the transverse direction X.

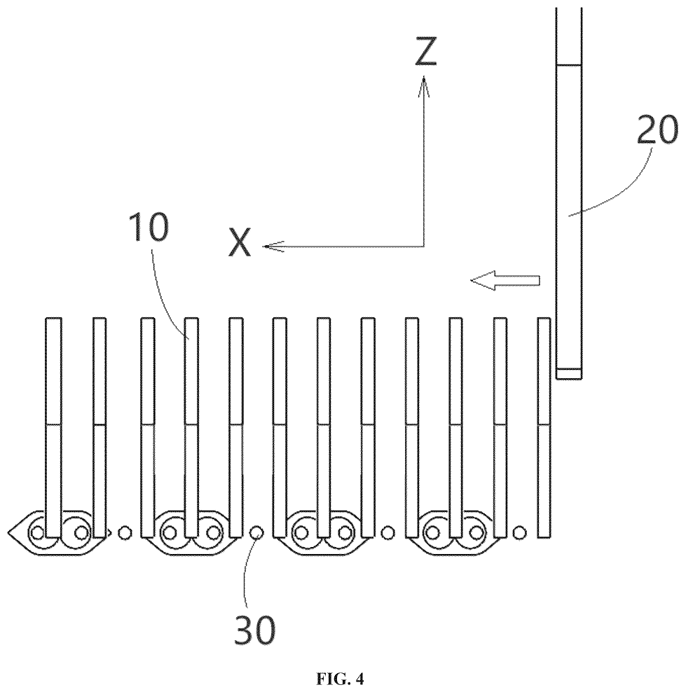

An exemplary embodiment of a welding strength detection device will now be described with reference to FIGS. 1-5. The welding strength detection device includes the comb tooth component 1, as described above, and a force detection device 2. The comb tooth component 1 is used to detect the welding strength of a row of welding points 30 on a welded product 3. As shown in FIG. 1, the force detection device 2 is capable of moving along the transverse direction X and has a detection finger 20 extending along the vertical direction Z perpendicular to the transverse direction X. The detection finger 20, as shown in FIG. 4, is used to sequentially push the row of elastic arms 10 of comb tooth component 1 along the transverse direction X.

As shown in FIG. 3, when detecting the row of welding points 30 on the welded product 3, the end portions 101 of the row of elastic arms 10 are arranged alternately with the row of welding points 30. The force detection device 2, as shown in FIG. 4, moves the detection finger 20 along the transverse direction X, and the row of elastic arms 10 sequentially pushes the row of welding points 30 under the push of the transversally moving detection finger 20.

The welding strength detection device further comprises a visual device and a judgment device. The visual device is set above the detected welding points 30 to capture an image of the detected welding points 30. The judgment device is used to determine whether the welding strength of welding point 30 has reached the predetermined welding strength based on the captured image. When the welding point 30 becomes loose under the push of the end portion 101 of the elastic arm 10, the judgment device determines that the welding strength of the welding point 30 has not reached the predetermined welding strength. When the welding point 30 does not loosen under the push of the end portion 101 of the elastic arm 10, the judgment device determines that the welding strength of the welding point 30 has reached the predetermined welding strength.

As shown in FIGS. 3-5, the detection finger 20 drives the elastic arm 10 to elastically deform towards the detected welding point 30 by transversally pushing the upper side edge of the elastic arm 10. When the elastic arm 10 is pushed by the detection finger 20, the lower side edge of the end portion 101 of the elastic arm 10 is transversally pressed against one side of the welding point 30 to push the welding point 30 transversally.

As shown in FIG. 5, when the elastic arm 10 is pushed by the detection finger 20, the detection finger 20 and the detected welding point 30 are spaced apart by a predetermined distance in the longitudinal direction Y perpendicular to the transverse direction X, so that a pushing force F2 applied by the end portion 101 of the elastic arm 10 on the welding point 30 is smaller than a pushing force F1 applied by the detection finger 20 on the elastic arm 10.

As shown in FIG. 1, the welding strength detection device further comprises a support seat 4, which is used to support the comb tooth component 1 and a part of the welded product 3. The connection block 11 of the comb tooth component 1 is rotatably connected to the support seat 4, allowing the comb tooth component 1 to be rotatably opened and closed relative to the support seat 4. As shown in FIGS. 3-4, when the comb tooth component 1 is closed, the end portions 101 of the row of elastic arms 10 of the comb tooth component 1 are pressed on the welded product 3 and arranged alternately with the row of welding points 30 to be detected.

As shown in FIG. 1, the welding strength detection device further includes a fixture 6, which is used to clamp the welded product 3 to prevent it from being moved during detection.

As shown in FIG. 1, the welding strength detection device further comprises a movable seat 5. The fixture 6 is installed on the movable seat 5. The movable seat 5 can move relative to the support seat 4 in the transverse direction X and the longitudinal direction Y to move the welded product 3 to the predetermined detection position.

As shown in FIG. 3, the welded product 3 includes a circuit board welded with a row of wires. As shown in FIG. 4, the end portion 101 of the elastic arm 10 of the comb tooth component 1 is adapted to be pushed against one side of the welding end of the wire under the push of the detection finger 20 to detect the welding strength of the welding point 30.

An exemplary embodiment of a welding strength detection method will now be described with reference to FIGS. 1-5. The welding strength detection method includes the following steps of: S10: providing the aforementioned welding strength detection device; S20: moving the welded product 3 to the predetermined detection position; S30: rotating the comb tooth component 1 to the closed position, so that the end portions 101 of the row of elastic arms 10 of the comb tooth component 1 are pressed on the welded product 3; and S40: transversally moving the detection finger 20 of the force detection device 2 to sequentially push the row of elastic arms 10 by the detection finger 20. In step S40, the row of elastic arms 10 sequentially push the row of welding points 30 on the welded product 3 under the push of the detection finger 20 that moves transversally, to detect the welding strength of the row of welding points 30.

As shown in FIG. 3, when the comb tooth component 1 is rotated to the closed position, the end portions 101 of the row of elastic arms 10 are arranged alternately with the row of welding points 30 on the welded product 3.

The welding strength detection method further comprises the steps of: S50: taking an image of the detected welding points 30; and S60: determining whether the welding strength of the detected welding point 30 has reached the predetermined welding strength based on the captured image.

When the welding point 30 becomes loose under the push of the end portion 101 of the elastic arm 10, the judgment device determines that the welding strength of the welding point 30 has not reached the predetermined welding strength. When the welding point 30 does not loosen under the push of the end portion 101 of the elastic arm 10, the judgment device determines that the welding strength of the welding point 30 has reached the predetermined welding strength.

In the aforementioned exemplary embodiments according to the present invention, the detection finger 20 does not need to directly contact the welding point 30, but contacts the welding point 30 through the elastic arm 10 of the comb tooth component 1, which can improve the accuracy of force detection and will not scratch the outer surface of the welding point 30, protecting the appearance of the welding point 30.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. A comb tooth component for detecting a welding strength of a welding point of a row of welding points, comprising:
a connection block; and
a row of elastic arms connected to one side of the connection block, the row of elastic arms has a comb tooth shape and extends along a longitudinal direction and is arranged in a row in a transverse direction perpendicular to the longitudinal direction, end portions of the row of elastic arms are arranged alternately with the row of welding points, the row of elastic arms sequentially push the row of welding points under a push of a transversally moving detection finger to detect the welding strength of the row of welding points.

2. The comb tooth component of claim 1, wherein when the welding strength of the welding point does not reach a predetermined welding strength, the welding point will loosen under the push of the end portion of one elastic arm.

3. The comb tooth component of claim 1, wherein when the welding strength of the welding point reaches a predetermined welding strength, the welding point will not loosen under the push of the end portion of one elastic arm.

4. The comb tooth component of claim 1, wherein each elastic arm is in the form of a sheet, each elastic arm has upper and lower sides opposite in a vertical direction perpendicular to the transverse direction and the longitudinal direction.

5. The comb tooth component of claim 1, wherein a lower side edge of each end portion rests against one side of the welding point along the transverse direction, the lower side edge pushes the welding point along the transverse direction.

6. A welding strength detection device, comprising:
a force detection device moving in a transverse direction and having a detection finger extending in a vertical direction perpendicular to the transverse direction; and
a comb tooth component for detecting a welding strength of a welding point of a row of welding points, including a connection block, and a row of elastic arms connected to one side of the connection block, the row of elastic arms has a comb tooth shape and extends along a longitudinal direction and is arranged in a row in the transverse direction perpendicular to the longitudinal direction, end portions of the row of elastic arms are arranged alternately with the row of welding points, the detection finger sequentially pushes the row of elastic arms along the transverse direction, the row of elastic arms sequentially pushes the row of welding points to detect the welding strength of the row of welding points.

7. The welding strength detection device of claim 6, wherein when detecting the row of welding points on a welded product, the end portions of the row of elastic arms are arranged alternately with the row of welding points, the force detection device moves the detection finger along the transverse direction, and the row of elastic arms sequentially push the row of welding points under a push of the detection finger.

8. The welding strength detection device of claim 7, further comprising a visual device provided above the row of welding points, the visual device captures images of the row of welding points.

9. The welding strength detection device of claim 8, further comprising a judgment device determining whether the welding strength of the welding point has reached a predetermined welding strength based on images captured by the visual device.

10. The welding strength detection device of claim 9, wherein when the welding point loosens under the push of the end portion of one elastic arm, the judgment device judges that the welding strength of the welding point has not reached the predetermined welding strength, and when the welding point does not loosen under the push of the end portion of the one elastic arm, the judgment device judges that the welding strength of the welding point has reached the predetermined welding strength.

11. The welding strength detection device of claim 6, wherein the detection finger drives one elastic arm to undergo elastic deformation towards the welding point by transversally pushing an upper side edge of the one elastic arm, when the one elastic arm is pushed by the detection finger, a lower side edge of the end portion of the one elastic arm transversally presses against one side of the welding point to transversally push the welding point.

12. The welding strength detection device of claim 11, wherein when the one elastic arm is pushed by the detection finger, the detection finger is spaced apart from the welding point by a predetermined distance in the longitudinal direction, a pushing force F2 applied by the end portion of one elastic arm on the welding point is smaller than a pushing force F1 applied by the detection finger on the one elastic arm.

13. The welding strength detection device of claim 7, further comprising a support seat supporting the comb tooth component and a portion of the welded product, the connection block is rotatably connected to the support seat such that the comb tooth component can be rotatably opened and closed relative to the support seat, when the comb tooth component is closed, the end portions of the row of elastic arms of the comb tooth component are pressed onto the welded product and arranged alternately with the row of welding points.

14. The welding strength detection device of claim 13, further comprising a fixture clamping the welded product to prevent it from being moved when detecting the welding strength of the row of welding points.

15. The welding strength detection device of claim 14, further comprising a movable seat, the fixture is installed on the movable seat, the movable seat moves relative to the support seat in the transverse direction and the longitudinal direction, the movable seat moves the welded product to a predetermined detection position.

16. The welding strength detection device of claim 15, wherein the welded product is a circuit board welded with a row of wires, the end portion of one elastic arm pushes against one side of a welding end of a wire of the row of wires under a push of the detection finger to detect the welding strength of the welding point.

17. A welding strength detection method, comprising:
moving a welded product to a predetermined detection position;
rotating a comb tooth component to a closed position, end portions of a row of elastic arms of the comb tooth component in the closed position are pressed onto the welded product; and
transversally moving a detection finger of a force detection device to sequentially push the row of elastic arms by the detection finger.

18. The method of claim 17, wherein when the comb tooth component is rotated to the closed position, the end portions of the row of elastic arms are arranged alternately with a row of welding points on the welded product, and, in the transversally moving a detection finger step, the row of elastic arms sequentially push the row of welding points on the welded product under the push of the detection finger to detect a welding strength of the row of welding points.

19. The method of claim 18, further comprising capturing an image of a welding point of the row of welding points of the welded product and determining whether the welding strength of the welding point has reached a predetermined welding strength based on the captured image.

20. The method of claim 19, wherein in the determining step, when the welding point loosens under the push of the end portion of one elastic arm, the judgment device judges that the welding strength of the welding point has not reached the predetermined welding strength, and when the welding point does not loosen under the push of the end portion of the one elastic arm, the judgment device judges that the welding strength of the welding point has reached the predetermined welding strength.
